(19) United States
(12) Patent Application Publication
(10) Pub. No.: US 2026/0285061 A1
(43) Pub. Date: Sep. 24, 2026

(54) PRINTING APPARATUS

(71) Applicant: KONICA MINOLTA, INC., Tokyo (JP)

(72) Inventor: Yasunori SHIGENAGA, Tokyo (JP)

(73) Assignee: KONICA MINOLTA, INC., Tokyo (JP)

(21) Appl. No.: 19/551,528

(22) Filed: Feb. 26, 2026

(30) Foreign Application Priority Data
Mar. 24, 2025 (JP) 2025-048639

(51) Int. Cl. B41J 11/00; B41J 13/00; B41J 13/22; C09D 11/101; C09D 11/30

(52) U.S. Cl. CPC B41J 11/00214; B41J 11/00212; B41J 13/0036; B41J 13/223; C09D 11/101; C09D 11/30

(57) ABSTRACT

Provided is a printing apparatus that includes: a conveyor that circulates and conveys a recording medium in a state in which the recording medium is held by a holder; an image former that forms an image by ejecting ink onto the recording medium during conveyance; an emitter that emits an energy ray to the recording medium on which the image has been formed; and a hardware processor that functions as a controller that controls the conveyor, the image former, and the emitter. In a case where a step of circulating and conveying the recording medium is repeated a plurality of times in a state in which the recording medium is held by the holder, the controller changes a printing condition for each of a plurality of the steps such that a glossiness of the image formed on the recording medium is partially different.

### CROSS REFERENCE TO RELATED APPLICATIONS

Japanese Patent Application No. 2025-048639, filed on Mar. 24, 2025, including description, claims, drawings, and abstract the entire disclosure is incorporated herein by reference in its entirety.

### BACKGROUND

### Technological Field

The present disclosure relates to a printing apparatus.

### Description of Related Art

For example, Japanese Patent Application Laid-Open No. 2002-264301 discloses a related art of a printing apparatus such as an inkjet printing apparatus. The printing apparatus described in Japanese Patent Application Laid-Open No. 2002-264301 includes a conveyor that conveys a sheet-like recording medium in the conveyance direction. The printing apparatus described in Japanese Patent Application Laid-Open No. 2002-264301 further includes: an image former (referred to as an ink ejection head in Japanese Patent Application Laid-Open No. 2002-264301) that forms an image by ejecting ink onto a recording medium during conveyance; and an emitter that emits ultraviolet rays to the recording medium on which the image has been formed.

### SUMMARY

There is generally known a method in which, in a case where ultraviolet curable (UV) gel ink is used as ink, the viscosity of the UV gel ink is decreased by increasing the surface temperature of a recording medium to decrease the glossiness of an image formed on the recording medium. However, although the glossiness of the image formed on the entire recording medium can be decreased, the glossiness of only an image formed on an arbitrary region of the recording medium cannot be decreased because the surface temperature of the entire recording medium changes.

In recent years, there is an increasing request by users for increasing the glossiness of a graphic image or a photographic image in an image formed on a recording medium or for decreasing the glossiness of a character image. In addition, it is also possible to increase the glossiness of only an image in an arbitrary region of a recording medium by locally applying varnish to an image formed on the recording medium with a post-processing machine, but the configuration of the printing apparatus including the post-processing machine becomes complicated.

Accordingly, an object of the present invention is to provide a printing apparatus capable of partially controlling the glossiness of an image formed in an arbitrary region of a recording medium while preventing the configuration of the printing apparatus from becoming complicated.

An aspect of a printing apparatus in the present invention includes:
a conveyor that circulates and conveys a recording medium in a state in which the recording medium is held by a holder;
an image former that forms an image by ejecting ink onto a recording medium during conveyance;
an emitter that emits an energy ray to the recording medium on which the image has been formed; and
a hardware processor that functions as a controller that controls the conveyor, the image former, and the emitter.

In a case where a step of circulating and conveying the recording medium is repeated a plurality of times in a state in which the recording medium is held by the holder, the controller changes a printing condition for each of a plurality of the steps such that a glossiness of the image formed on the recording medium is partially different.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic front view of an inkjet printing apparatus according to the present embodiment;

FIG. 2 is a control block diagram of the inkjet printing apparatus according to the present embodiment;

FIG. 3A is a conceptual diagram illustrating how ink landed on a recording medium has spread and has been cured;

FIG. 3B is a conceptual diagram illustrating how ink landed on a recording medium has been cured without spreading;

FIG. 3C is a conceptual diagram illustrating how ink landed on a recording medium has further spread and has been cured;

FIG. 4 is a flowchart illustrating a flow of operations in a first control aspect of the inkjet printing apparatus according to the present embodiment;

FIG. 5 is a flowchart illustrating a flow of operations in a second control aspect of the inkjet printing apparatus according to the present embodiment;

FIG. 6 is a flowchart illustrating a flow of operations in a third control aspect of the inkjet printing apparatus according to the present embodiment; and

FIG. 7 is a flowchart illustrating a flow of operations in a fourth control aspect of the inkjet printing apparatus according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

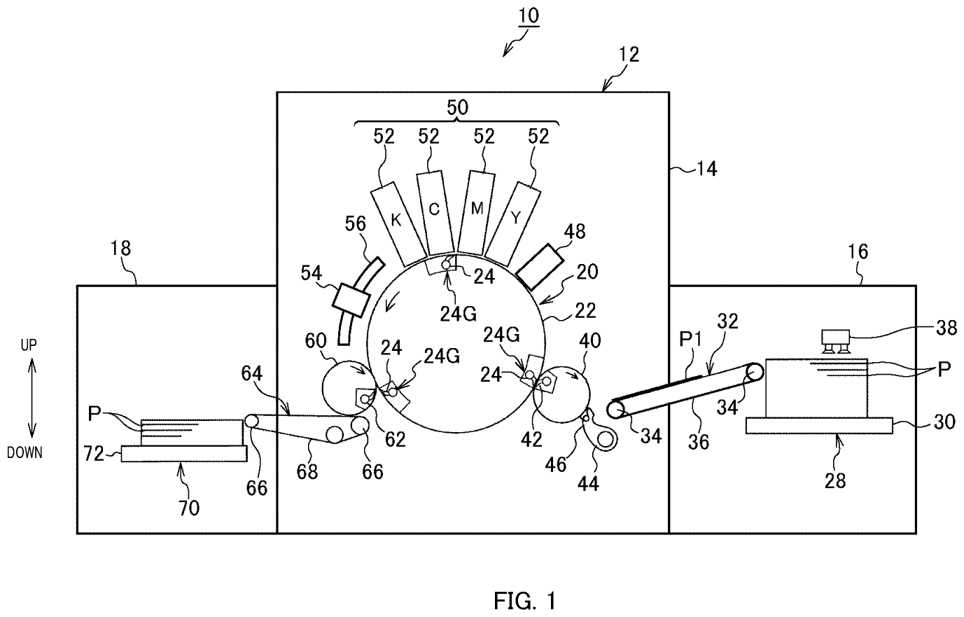

Hereinafter, the present embodiment will be described with reference to the accompanying drawings. In the present embodiment, the conveyance direction refers to a direction in which a recording medium is conveyed. The downstream side refers to the downstream side in the conveyance direction, and the upstream side refers to the upstream side in the conveyance direction. The conveyance width direction refers to a direction orthogonal to the conveyance direction and is the front-rear direction in FIG. 1.

The overall configuration of an inkjet printing apparatus 10 according to the present embodiment will be described with reference to FIG. 1. FIG. 1 is a schematic front view of the inkjet printing apparatus 10 according to the present embodiment.

As illustrated in FIG. 1, the inkjet printing apparatus 10 according to the present embodiment is a single-pass printing apparatus that performs an image formation (printing) on a recording medium P having a sheet-like shape while conveying the recording medium P in the conveyance direction. As the recording medium P, in addition to paper such as plain paper and coated paper, various media such as fabric and a resin film can be used.

The inkjet printing apparatus 10 includes a printing apparatus main body 12 extending in the left-right direction in FIG. 1. The printing apparatus main body 12 includes: a center frame 14; a first side frame 16 disposed on one side of the center frame 14; and a second side frame 18 disposed on the other side of the center frame 14.

The inkjet printing apparatus 10 includes a conveyor 20 that circulates and conveys the recording medium P while holding the recording medium P, and the conveyor 20 is provided in the center frame 14. The conveyor 20 includes a printing cylinder 22 rotatably provided in the center frame 14, and the printing cylinder 22 rotates while carrying the recording medium P.

The printing cylinder 22 includes a plurality of holding claws 24, which holds a leading end portion of the recording medium P, on the outer peripheral surface side of the printing cylinder 22, and the plurality of holding claws 24 corresponds to the holder that holds the recording medium P. The plurality of holding claws 24 is divided into a plurality of (for example, three) claw groups 24G, and the plurality of claw groups 24G is arranged at equal intervals on the outer periphery surface of the printing cylinder 22. The plurality of holding claws 24 (only one holding claw 24 is illustrated) of each claw group 24G is arranged at intervals along the conveyance width direction (the front-rear direction in FIG. 1).

The outer periphery surface of the printing cylinder 22 serves as a conveyance surface of the conveyor 20, and a plurality of adsorption sections (not illustrated) that adsorbs the recording medium P is provided on the outer periphery surface of the printing cylinder 22. The adsorption method of the plurality of adsorption sections may be any one of suction adsorption and electrostatic adsorption.

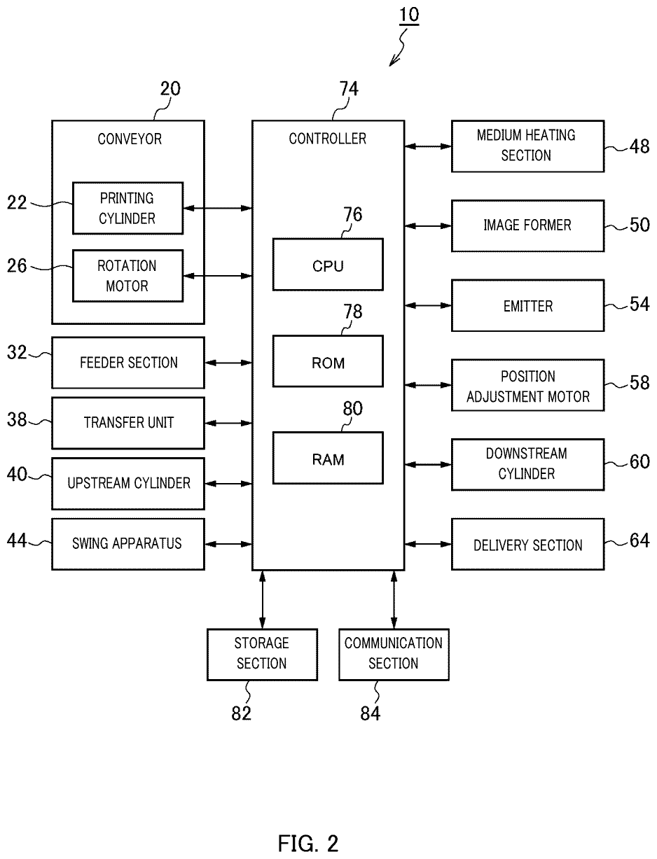

The conveyor 20 includes a rotation motor 26 (see FIG. 2) as a drive source that rotates the printing cylinder 22, and the rotation motor 26 is provided at an appropriate position of the center frame 14. In a state in which the leading end portion of the recording medium P is held by the plurality of holding claws 24 of any one of the claw groups 24G, the printing cylinder 22 is rotated by the driving of the rotation motor 26, and thus, the recording medium P is circulated and conveyed. In other words, the conveyor 20 circulates and conveys the recording medium P in a state in which the leading end portion of the recording medium P is held by the plurality of holding claws 24 of any one of the claw groups 24G.

As illustrated in FIG. 1, the inkjet printing apparatus 10 includes a first stacking section 28 for stacking a plurality of recording media P, and the first stacking section 28 is provided in the first side frame 16. The first stacking section 28 includes a placement tray 30 for placing the recording medium P, and the placement tray 30 is provided in the first side frame 16 so as to be movable up and down. The placement tray 30 is configured to move up and down according to the amount of recording media P to be placed, and the uppermost recording medium P is held at a predetermined height position.

As illustrated in FIG. 1, the inkjet printing apparatus 10 includes a feeder section 32 that supplies the recording medium P, which has been transferred from the side of the placement tray 30, to the side of the conveyor 20 (the conveyance direction). The feeder section 32 is provided from the first side frame 16 to the center frame 14, and is disposed between the printing cylinder 22 and the first stacking section 28. The feeder section 32 includes: a plurality of support rollers 34, which is capable of rotating; and a belt 36 having an endless shape, which is provided so as to be wound around the plurality of support rollers 34. In addition, any one of the support rollers 34 is interlocked with and coupled to an output shaft of the rotation motor 26.

As illustrated in FIG. 1, the inkjet printing apparatus 10 includes a transfer unit 38 that transfers the topmost recording medium P stacked on the placement tray 30 to the feeder section 32. The transfer unit 38 is provided above the first stacking section 28 in the first side frame 16. In addition, a plurality of registration sections (not illustrated) that positions the recording medium P is provided on the downstream end side of the feeder section 32, and the plurality of registration sections is arranged at intervals along the conveyance width direction. Each registration section includes an abutment surface that can abut on the leading end surface of the recording medium P, and is configured to be swingable in the up-down direction.

The belt 36 is circulated by the rotation of the plurality of support rollers 34, thereby supplying the recording medium P, which has been transferred by the transfer unit 38, to the side of the printing cylinder 22. Then, the recording medium P is positioned at a predetermined position on the feeder section 32 such that the leading end surface of the recording medium P abuts on the abutment surface of the plurality of registration sections and becomes parallel to the conveyance width direction.

As illustrated in FIG. 1, the inkjet printing apparatus 10 includes an upstream cylinder 40 that delivers the recording medium P to the printing cylinder 22. The upstream cylinder 40 is rotatably provided on the upstream side of the printing cylinder 22 in the center frame 14. The upstream cylinder 40 is disposed adjacent to the printing cylinder 22, and rotates while carrying the recording medium P. The upstream cylinder 40 is configured to rotate in the direction opposite to the rotation direction of the printing cylinder 22 in conjunction with the rotation of the printing cylinder 22. The diameter of the upstream cylinder 40 is one third of the diameter of the printing cylinder 22, and the upstream cylinder 40 is configured to perform one rotation when the printing cylinder 22 performs a one-third rotation.

A plurality of holding claws 42 (only one holding claw 42 is illustrated) that holds the leading end portion of the recording medium P is provided on the outer peripheral surface side of the upstream cylinder 40, and the plurality of holding claws 42 is arranged at intervals in the conveyance width direction. The plurality of holding claws 42 of the upstream cylinder 40 and the plurality of holding claws 24 of any one of the claw groups 24G of the printing cylinder 22 perform a gripping change operation of the recording medium P in a state of being close to each other. The plurality of holding claws 24 of any one of the claw groups 24G in the printing cylinder 22 receives the leading end portion of the recording medium P from the plurality of holding claws 42 of the upstream cylinder 40 and holds the leading end portion of the recording medium P.

As illustrated in FIG. 1, the inkjet printing apparatus 10 includes a swing apparatus 44 that delivers the recording medium P from the side of the feeder section 32 to the upstream cylinder 40. The swing apparatus 44 is provided to be swingable between the upstream cylinder 40 and the feeder section 32 in the center frame 14. A plurality of holding claws 46 (only one holding claw 46 is illustrated) that holds the leading end portion of the recording medium P is provided at a leading end portion of the swing apparatus 44, and the plurality of holding claws 46 is arranged at intervals in the conveyance width direction. Swinging the swing apparatus 44 causes the plurality of holding claws 46 to move between a position corresponding to (a position approaching) the downstream end of the feeder section 32 and a position corresponding to the upstream cylinder 40.

After the plurality of holding claws 46 of the swing apparatus 44 is moved to the position corresponding to the downstream end of the feeder section 32, the plurality of holding claws 46 of the swing apparatus 44 receives the leading end portion of the recording medium, which has been positioned at the predetermined position of the feeder section 32 by the plurality of registration sections, and holds the leading end portion of the recording medium. Note that, immediately after the plurality of holding claws 46 of the swing apparatus 44 holds the leading end portion of the recording medium P, the plurality of registration sections swings in the down direction and separates from the recording medium P.

After the plurality of holding claws 46 of the swing apparatus 44 is moved to the position corresponding to the upstream cylinder 40, the plurality of holding claws 46 of the swing apparatus 44 and the plurality of holding claws 42 of the upstream cylinder 40 perform a gripping change operation of the recording medium P in a state of being close to each other. The plurality of holding claws 42 of the upstream cylinder 40 receives the leading end portion of the recording medium P from the plurality of holding claws 46 of the swing apparatus 44 and holds the leading end portion of the recording medium P.

As illustrated in FIG. 1, the inkjet printing apparatus 10 includes a medium heating section 48 that heats the recording medium P carried on the printing cylinder 22, and the medium heating section 48 is provided on the downstream side of the upstream cylinder 40 in the center frame 14. The medium heating section 48 is disposed to face the outer periphery surface of the printing cylinder 22. The medium heating section 48 includes, for example, an infrared ray heater or the like, and heats the printing cylinder 22 and the recording medium P such that the recording medium P conveyed by the printing cylinder 22 has a temperature within a predetermined range.

As illustrated in FIG. 1, the inkjet printing apparatus 10 includes an image former 50 that forms an image by ejecting ink onto the recording medium P during conveyance. The image former 50 is provided on the downstream side of the medium heating section 48 in the center frame 14. The image former 50 includes a plurality of inkjet sections 52 that ejects inks of four colors of yellow (Y), magenta (M), cyan (C), and black (K) onto the recording medium P carried on the printing cylinder 22. The plurality of inkjet sections 52 corresponding to the inks of the four colors of Y, M, C, and K is arranged at intervals along the conveyance direction.

Each of the inkjet sections 52 includes a plurality of inkjet heads (not illustrated) that ejects ink onto the recording medium P. A plurality of nozzles (not illustrated) for ejecting ink is formed at a leading end portion of each inkjet head. The plurality of inkjet heads is arranged, for example, in a staggered pattern along the conveyance width direction. In other words, each of the inkjet sections 52 forms a line head including the plurality of inkjet heads.

Ultraviolet curable ink (UV ink) that is cured (solidified) by the emission of ultraviolet rays, which are one type of energy rays, is used as the ink that is ejected from the inkjet section 52. In particular, UV gel ink, which undergoes a phase change between a gel state and a sol state (liquid state) depending on the temperature, is used among UV inks. Note that, in addition to the UV ink, any other ink having a property of being dried or cured by energy rays such as infrared rays or an electron beam may also be used as the ink that is ejected from the inkjet section 52.

As illustrated in FIG. 1, the inkjet printing apparatus 10 includes an emitter 54 that emits ultraviolet rays to the recording medium P on which an image has been formed. The emitter 54 is provided on the downstream side of the image former 50 in the center frame 14, and is disposed to face the outer periphery surface of the printing cylinder 22. By emitting ultraviolet rays from the emitter 54 to the recording medium P, the ink on the recording medium P can be cured to fix the image on the recording medium P. Note that, in a case where another ink is used as the ink that is ejected from the inkjet section 52, the emitter 54 emits energy rays corresponding to the properties of the other ink.

On the downstream side of the image former 50 in the center frame 14, a guide member 56 may be provided which guides the emitter 54 in an arc direction in which the emitter 54 approaches or separates from the image former 50 in a state in which a gap between the emitter 54 and the outer periphery surface of the printing cylinder 22 is maintained constant. The guide member 56 extends in an arc direction centering on the center of the printing cylinder 22. In addition, a position adjustment motor 58 (see FIG. 2) as a position adjuster that adjusts the position of the emitter 54 in an arc direction approaching and separating from the image former 50 may be provided at an appropriate position of the center frame 14.

As illustrated in FIG. 1, the inkjet printing apparatus 10 includes a downstream cylinder 60 that receives the recording medium P on which an image formation has been performed (printing has been performed) from the printing cylinder 22. The downstream cylinder 60 is rotatably provided on the downstream side of the printing cylinder 22 in the center frame 14. The downstream cylinder 60 is disposed adjacent to the printing cylinder 22, and rotates while carrying the recording medium P on which an image formation has been performed. The downstream cylinder 60 is configured to rotate in the direction opposite to the rotation direction of the printing cylinder 22 in conjunction with the rotation of the printing cylinder 22. The diameter of the downstream cylinder 60 is one third of the diameter of the printing cylinder 22, and the downstream cylinder 60 is configured to perform one rotation when the printing cylinder 22 performs a one-third rotation.

The downstream cylinder 60 includes a plurality of holding claws 62 (only one holding claw 62 is illustrated), which holds the leading end portion of the recording medium P on which an image formation has been performed, on the outer peripheral surface side of the downstream cylinder 60, and the plurality of holding claws 62 is arranged at intervals in the conveyance width direction. The plurality of holding claws 62 of the downstream cylinder 60 and the plurality of holding claws 24 of any one of the claw groups 24G of the printing cylinder 22 perform a gripping change operation of the recording medium P. The plurality of holding claws 62 of the downstream cylinder 60 receive the leading end of the recording medium P, on which an image formation has been performed, from the plurality of holding claws 24 of any one of the claw groups 24G of the printing cylinder 22 and holds the leading end of the recording medium P.

As illustrated in FIG. 1, the inkjet printing apparatus 10 includes a delivery section 64 that conveys the recording medium P which has been fed out from the downstream cylinder 60 and on which an image formation has been performed. The delivery section 64 is provided from the center frame 14 to the second side frame 18. The delivery section 64 includes: a plurality of support rollers 66, which is capable of rotating; and a belt 68 having an endless shape, which is wound around the plurality of support rollers 66. In addition, any one of the support rollers 66 is interlocked with and coupled to the output shaft of the rotation motor 26. By circulating the belt 68 by the rotation of the plurality of support rollers 66, the recording medium P on which an image formation has been performed and which has been fed out from the downstream cylinder 60 is conveyed in the conveyance direction.

As illustrated in FIG. 1, the inkjet printing apparatus 10 includes a second stacking section 70 for stacking a plurality of recording media P on which an image formation have been formed, and the second stacking section 70 is provided in the second side frame 18. The second stacking section 70 includes a placement tray 72 for placing the recording medium P on which an image formation has been performed. The second stacking section 70 accommodates the recording medium P until the user takes out the recording medium P from the placement tray 72.

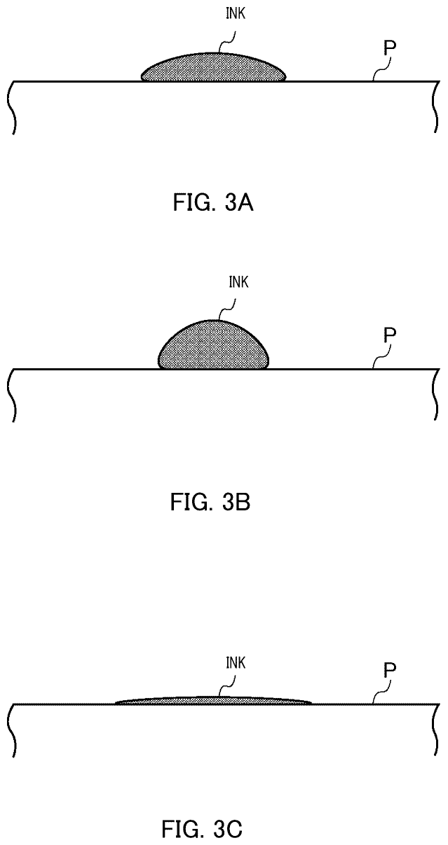

The control configuration of the inkjet printing apparatus 10 according to the present embodiment will be described with reference to FIGS. 1 to 3C. FIG. 2 is a control block diagram of the inkjet printing apparatus 10 according to the present embodiment. FIG. 3A is a conceptual diagram illustrating how ink (ink dot) landed on the recording medium P has spread and has been cured. FIG. 3B is a conceptual diagram illustrating how ink landed on the recording medium P has been cured without spreading. FIG. 3C is a conceptual diagram illustrating how ink landed on the recording medium P has further spread and has been cured.

As illustrated in FIG. 2, the inkjet printing apparatus 10 includes a controller 74 that controls the printing cylinder 22, the rotation motor 26, the feeder section 32, the upstream cylinder 40, the swing apparatus 44, the image former 50, the emitter 54, the position adjustment motor 58, the downstream cylinder 60, and the like. The controller 74 plays a role in governing the control of the inkjet printing apparatus 10 in its entirety. The controller 74 includes a central processing unit (CPU) 76, a read only memory (ROM) 78, and a random access memory (RAM) 80. A storage section 82 and a communication section 84 are connected to the controller 74.

The CPU 76 comprehensively controls the entire operation of the inkjet printing apparatus 10. The CPU 76 reads various kinds of control programs and setting data stored in the ROM 78, stores the read programs and setting data in the RAM 80, and executes the programs to perform various kinds of arithmetic processing. In addition, the RAM 80 provides a working memory space to the CPU 76 and stores temporary data. The RAM 80 may include a non-volatile memory.

When performing various kinds of arithmetic processing, the CPU 76 refers to various kinds of data stored in the storage section 82. The storage section 82 is constituted by, for example, a non-volatile semiconductor memory or a hard disk drive.

The controller 74 transmits and receives various kinds of data to and from an external apparatus (for example, a computer) connected to a network such as a local area network (LAN) or a wide area network (WAN) via the communication section 84. For example, the controller 74 receives a print job transmitted from the external apparatus, and controls the image former 50 based on image data included in the print job. The communication section 84 is constituted by, for example, a communication control card such as a LAN card.

The controller 74 (the CPU 76) has the following configuration by executing various kinds of control programs.

As illustrated in FIGS. 1 and 2, in a case where a step of circulating and conveying the recording medium P is repeated a plurality of times in a state in which the recording medium P is held by the plurality of holding claws 24, the controller 74 changes a printing condition (image formation condition) for each step. Specifically, in a case where the step of circulating and conveying the recording medium P is repeated a plurality of times, the controller 74 changes the printing condition for each step such that the glossiness of the image formed on the recording medium P is partially different. In other words, in a case where the step of circulating and conveying the recording medium P is a plurality of times, the controller 74 changes the printing condition for each step such that an image with a high glossiness is formed in an arbitrary region of the recording medium P or an image with a low glossiness is formed in another arbitrary region of the recording medium P.

The controller 74 selects, as the printing condition, one of the conveyance speed of the recording medium P by the rotation of the printing cylinder 22 (the conveyance speed of the recording medium P by the conveyor 20), the emission light amount of ultraviolet rays by the emitter 54, and the separation distance between the emitter 54 and the image former 50. The image with a high glossiness is, for example, an image including a graphic image and/or a photographic image. The image with a low glossiness is, for example, an image including a character image and/or a line image.

In a case where the conveyance speed of the recording medium P by the rotation of the printing cylinder 22 is selected as the printing condition in a first control aspect, the controller 74 controls the rotation motor 26 as follows.

As illustrated in FIG. 1, in a case where an image with a high glossiness is formed in an arbitrary region of the recording medium P in a first step, the controller 74 controls the rotation motor 26 such that the conveyance speed of the recording medium P is slower than in a case where an image with a low glossiness is formed. Specifically, the controller 74 controls the rotation motor 26 such that in the first step, the conveyance speed of the recording medium P becomes a first conveyance speed slower than the normal conveyance speed. By causing the conveyance speed of the recording medium P to be slower, the time until the ink ejected onto the recording medium P is cured becomes longer and, as illustrated in FIG. 3A, the ink (ink dots) spreads and the bulk of the ink becomes lower. As a result, the glossiness of the image formed in the arbitrary region of the recording medium P increases.

In a case where an image with a low glossiness is formed in another arbitrary region of the recording medium P in a second step after the first step ends, the controller 74 controls the rotation motor 26 such that the conveyance speed of the recording medium P is faster than in a case where an image with a high glossiness is formed. Specifically, the controller 74 controls the rotation motor 26 such that in the second step, the conveyance speed of the recording medium P becomes a second conveyance speed equal to or faster than the normal conveyance speed. By causing the conveyance speed of the recording medium P to be faster, the time until the ink ejected onto the recording medium P is cured becomes shorter and, as illustrated in FIG. 3B, the ink does not spread and the bulk of the ink becomes higher. As a result, the glossiness of the image formed in the other arbitrary region of the recording medium P decreases.

Note that, in the first control aspect, an image with a high glossiness may be formed in an arbitrary region of the recording medium P in the second step, and an image with a low glossiness may be formed in another arbitrary region of the recording medium P in the first step. An image with a high glossiness may be formed in another arbitrary region of the recording medium P, and an image with a low glossiness may be formed in an arbitrary region of the recording medium P.

In a case where the conveyance speed of the recording medium P is selected as the printing condition and an image with a higher glossiness is formed in an arbitrary region of the recording medium P in a second control aspect, the controller 74 controls the rotation motor 26, the image former 50, and the emitter 54 as follows.

As illustrated in FIG. 1, the controller 74 controls the rotation motor 26, the image former 50, and the emitter 54 such that in a first step, an image is formed by ejecting ink onto an arbitrary region of the recording medium P in a state in which the emission of ultraviolet rays is stopped. The controller 74 controls the rotation motor 26 and the emitter 54 such that ultraviolet rays are emitted to the recording medium P in a second step after the first step ends. By emitting ultraviolet rays to the recording medium P in the second step, the time until the ink ejected onto the recording medium P is cured becomes much longer and, as illustrated in FIG. 3C, the ink spreads more and the bulk of the ink becomes extremely lower. As a result, the glossiness of the image formed in the arbitrary region of the recording medium P becomes much higher.

In addition, the controller 74 controls the rotation motor 26 such that in a third step after the second step ends, the conveyance speed of the recording medium P becomes a second conveyance speed equal to or faster than the normal conveyance speed. By causing the conveyance speed of the recording medium P to be faster, the time until the ink ejected onto the recording medium P is cured becomes shorter and, as illustrated in FIG. 3B, the ink does not spread and the bulk of the ink becomes higher. As a result, the glossiness of the image formed in the other arbitrary region of the recording medium P decreases.

Note that, in the second control aspect, an image with a low glossiness may be formed in another arbitrary region of the recording medium P, instead of the third step, in a previous step before the start of the first step. An image with a higher glossiness may be formed in another arbitrary region of the recording medium P, and an image with a low glossiness may be formed in an arbitrary region of the recording medium P.

In a case where the emission light amount of ultraviolet rays is selected as the printing condition in a third control aspect, the controller 74 controls the emitter 54 as follows.

As illustrated in FIG. 1, in a case where an image with a high glossiness is formed in an arbitrary region of the recording medium P in a first step, the controller 74 controls the emitter 54 such that the emission light amount of ultraviolet rays is larger than in a case where an image with a low glossiness is formed. Specifically, the controller 74 controls the emitter 54 such that in the first step, ultraviolet rays in a first emission light amount larger than the normal emission light amount are emitted. By increasing the emission light amount of the ultraviolet rays, the ink ejected onto the recording medium P spreads and the bulk of the ink becomes lower as illustrated in FIG. 3A. As a result, the glossiness of the image formed in the arbitrary region of the recording medium P increases.

In a case where an image with a low glossiness is formed in another arbitrary region of the recording medium P in a second step after the first step ends, the controller 74 controls the emitter 54 such that the emission light amount of ultraviolet rays is smaller than in a case where an image with a high glossiness is formed. Specifically, the controller 74 controls the emitter 54 such that in the second step, ultraviolet rays in a second emission light amount equal to or smaller than the normal emission light amount are emitted. By causing the emission light amount of ultraviolet rays to be smaller, the ink ejected onto the recording medium P does not spread and the bulk of the ink becomes higher as illustrated in FIG. 3B. As a result, the glossiness of the image formed in the other arbitrary region of the recording medium P decreases.

Note that, in the third control aspect, an image with a high glossiness may be formed in an arbitrary region of the recording medium P in the second step, and an image with a low glossiness may be formed in another arbitrary region of the recording medium P in the first step. An image with a high glossiness may be formed in another arbitrary region of the recording medium P, and an image with a low glossiness may be formed in an arbitrary region of the recording medium P.

In a case where the separation distance between the emitter 54 and the image former 50 is selected as the printing condition in a fourth control aspect, the controller 74 controls the position adjustment motor 58 as follows.

In a case where an image with a high glossiness is formed on an arbitrary region of the recording medium P in the first step, the controller 74 controls the position adjustment motor 58 such that the separation distance between the emitter 54 and the image former 50 is longer than in a case where an image with a low glossiness is formed. Specifically, the controller 74 controls the position adjustment motor 58 such that in the first step, the separation distance between the emitter 54 and the image former 50 becomes a first separation distance longer than the normal separation distance. By causing the separation distance between the emitter 54 and the image former 50 to be longer, the time until the ink ejected onto the recording medium P is cured becomes longer and, as illustrated in FIG. 3A, the ink spreads and the bulk of the ink becomes lower. As a result, the glossiness of the image formed in the arbitrary region of the recording medium P increases.

In a case where an image with a low glossiness is formed in another arbitrary region of the recording medium P in a second step, the controller 74 controls the position adjustment motor 58 such that the separation distance between the emitter 54 and the image former 50 is shorter than in a case where an image with a high glossiness is formed. Specifically, the controller 74 controls the position adjustment motor 58 such that the separation distance between the emitter 54 and the image former 50 becomes a second separation distance equal to or shorter than the normal separation distance. By causing the separation distance between the emitter 54 and the image former 50 to be shorter, the time until the ink ejected onto the recording medium P cures becomes shorter and, as illustrated in FIG. 3B, the ink does not spread and the bulk of the ink becomes higher. As a result, the glossiness of the image formed in the other arbitrary region of the recording medium P decreases.

Note that, in the fourth control aspect, an image with a high glossiness may be formed in an arbitrary region of the recording medium P in the second step, and an image with a low glossiness may be formed in another arbitrary region of the recording medium P in the first step. An image with a high glossiness may be formed in another arbitrary region of the recording medium P, and an image with a low glossiness may be formed in an arbitrary region of the recording medium P.

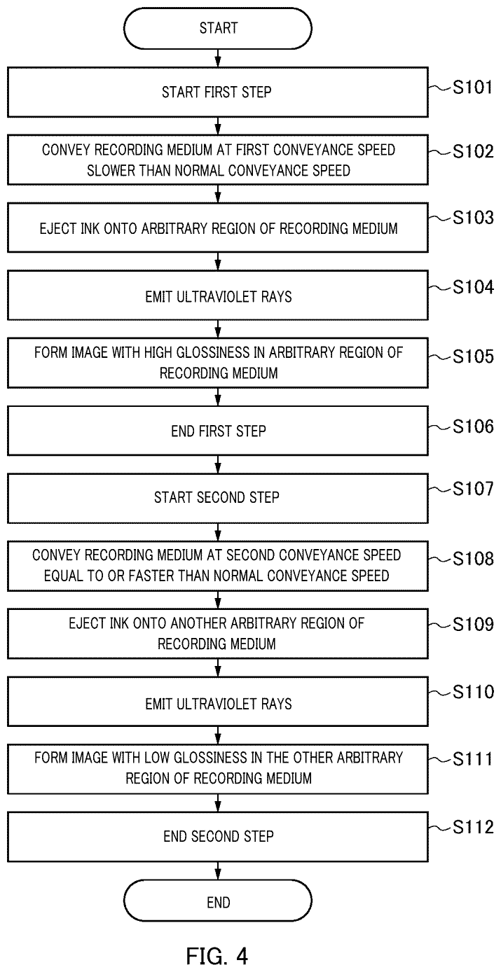

A flow of operations in the first control aspect of the inkjet printing apparatus 10 will be described with reference to FIGS. 1, 2, and 4. FIG. 4 is a flowchart illustrating the flow of operations in the first control aspect of the inkjet printing apparatus 10 according to the present embodiment.

As illustrated in FIGS. 1, 2, and 4, the first step is started when the plurality of holding claws 24 of the printing cylinder 22 receives the leading end portion of the recording medium P from the plurality of holding claws 42 of the upstream cylinder 40 and holds the leading end portion (step S101 in FIG. 4). In addition, the controller 74 controls the rotation motor 26 such that the conveyance speed of the recording medium P becomes the first conveyance speed slower than the normal conveyance speed, and thus, the recording medium P is conveyed at the first conveyance speed (step S102 in FIG. 4).

The controller 74 controls the image former 50 such that ink is ejected from the plurality of inkjet sections 52 onto an arbitrary region of the recording medium P during conveyance (step S103 in FIG. 4). Subsequently, the controller 74 controls the emitter 54 such that ultraviolet rays are emitted to the recording medium P during conveyance (step S104 in FIG. 4). Thus, an image with a high glossiness can be formed in the arbitrary region of the recording medium P during conveyance (step S105 in FIG. 4), and the first step ends (step S106 in FIG. 4).

After the first step ends, the second step is started in a state in which the plurality of holding claws 24 of the printing cylinder 22 holds the leading end portion of the recording medium P (step S107 in FIG. 4). The controller 74 controls the rotation motor 26 such that the conveyance speed of the recording medium P becomes the second conveyance speed equal to or faster than the normal conveyance speed, and thus, the recording medium P is conveyed at the second conveyance speed (step S108 in FIG. 4). Note that, although the second step is started when or after the printing cylinder 22 enters the second rotation, the second step may also be started before the printing cylinder 22 enters the second rotation.

The controller 74 controls the image former 50 such that ink is ejected from the plurality of inkjet sections 52 onto another arbitrary region of the recording medium P during conveyance (step S109 in FIG. 4). Subsequently, the controller 74 controls the emitter 54 such that ultraviolet rays are emitted to the recording medium P during conveyance (step S110 in FIG. 4). Thus, an image with a low glossiness can be formed in the other arbitrary region of the recording medium P during conveyance (step S111 in FIG. 4). Then, the second step ends when the plurality of holding claws 62 of the downstream cylinder 60 receives the leading end portion of the recording medium P, on which an image formation has been performed, from the plurality of holding claws 24 of the printing cylinder 22 and holds the leading end portion (step S112 in FIG. 4).

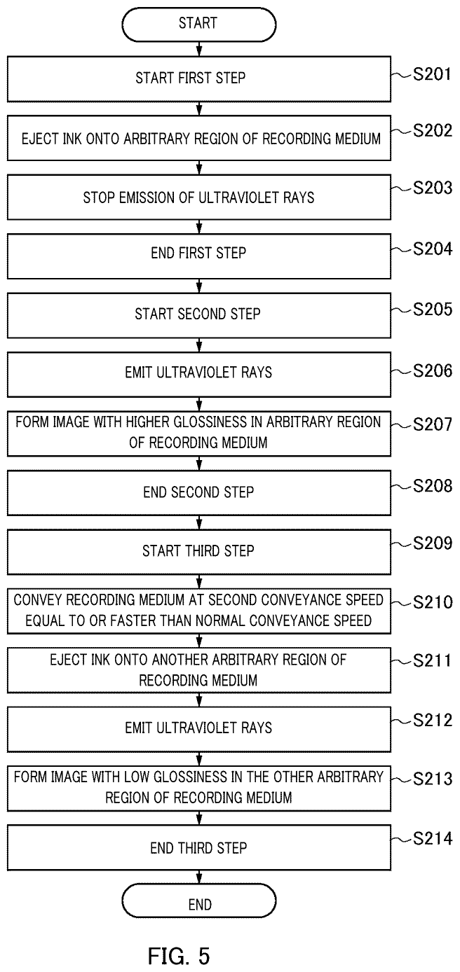

A flow of operations in the second control aspect of the inkjet printing apparatus 10 will be described with reference to FIGS. 1, 2, and 5. FIG. 5 is a flowchart illustrating the flow of operations in the second control aspect of the inkjet printing apparatus 10 according to the present embodiment.

As illustrated in FIGS. 1, 2, and 5, the first step is started when the plurality of holding claws 24 of the printing cylinder 22 receives the leading end portion of the recording medium P from the plurality of holding claws 42 of the upstream cylinder 40 and holds the leading end portion (step S201 in FIG. 5). In addition, the controller 74 controls the rotation motor 26 such that the conveyance speed of the recording medium P becomes the normal conveyance speed, and thus, the recording medium P is conveyed at the normal conveyance speed.

The controller 74 controls the image former 50 such that ink is ejected from the plurality of inkjet sections 52 onto an arbitrary region of the recording medium P during conveyance (step S202 in FIG. 5). On the other hand, the controller 74 causes the emission of ultraviolet rays from the emitter 54 to be in a stopped state during the first step (step S203 in FIG. 5). Then, the first step ends when the conveyance of the recording medium P is continued by the rotation of the printing cylinder 22 (step S204 in FIG. 5).

When or after the printing cylinder 22 enters the second rotation, the second step is started in a state in which the plurality of holding claws 24 of the printing cylinder 22 holds the leading end portion of the recording medium P (step S205 in FIG. 5). In addition, the controller 74 controls the rotation motor 26 such that the recording medium P is continuously conveyed at the normal conveyance speed. Subsequently, the controller 74 controls the emitter 54 such that ultraviolet rays are emitted to the recording medium P during conveyance (step S206 in FIG. 5). Thus, an image with a higher glossiness can be formed in the arbitrary region of the recording medium P during conveyance (step S207 in FIG. 5), and the second step ends (step S208 in FIG. 5).

After the second step ends, the third step is started in a state in which the plurality of holding claws 24 of the printing cylinder 22 holds the leading end portion of the recording medium P (step S209 in FIG. 5). In addition, the controller 74 controls the rotation motor 26 such that the conveyance speed of the recording medium P becomes the second conveyance speed equal to or faster than the normal conveyance speed, and thus, the recording medium P is conveyed at the second conveyance speed (step S210 of FIG. 5). Note that, although the third step is started when or after the printing cylinder 22 enters the third rotation, the third step may be started before the printing cylinder 22 enters the third rotation.

The controller 74 controls the image former 50 such that ink is ejected from the plurality of inkjet sections 52 onto another arbitrary region of the recording medium P during conveyance (step S211 in FIG. 5). Subsequently, the controller 74 controls the emitter 54 such that ultraviolet rays are emitted to the recording medium P during conveyance (step S212 in FIG. 5). Thus, an image with a low glossiness can be formed in the other arbitrary region of the recording medium P during conveyance (step S213 in FIG. 5). Then, the third step ends when the plurality of holding claws 62 of the downstream cylinder 60 receives the leading end portion of the recording medium P, on which an image formation has been performed, from the plurality of holding claws 24 of the printing cylinder 22 and holds the leading end portion (step S214 in FIG. 5).

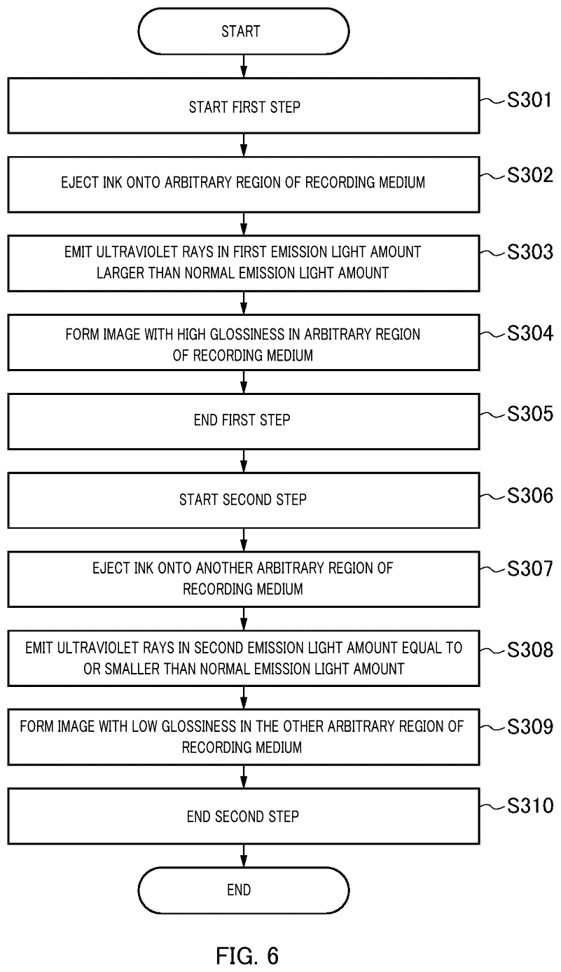

A flow of operations in the third control aspect of the inkjet printing apparatus 10 will be described with reference to FIGS. 1, 2, and 6. FIG. 6 is a flowchart illustrating the flow of operations in the third control aspect of the inkjet printing apparatus 10 according to the present embodiment.

As illustrated in FIGS. 1, 2, and 6, the first step is started when the plurality of holding claws 24 of the printing cylinder 22 receives the leading end portion of the recording medium P from the plurality of holding claws 42 of the upstream cylinder 40 and holds the leading end portion (step S301 in FIG. 6). In addition, the controller 74 controls the rotation motor 26 such that the conveyance speed of the recording medium P becomes the normal conveyance speed, and thus, the recording medium P is conveyed at the normal conveyance speed.

The controller 74 controls the image former 50 such that ink is ejected from the plurality of inkjet sections 52 onto an arbitrary region of the recording medium P during conveyance (step S302 in FIG. 6). Subsequently, the controller 74 controls the emitter 54 such that ultraviolet rays in the first emission light amount larger than the normal emission light amount are emitted to the recording medium P during conveyance (step S303 in FIG. 6). Thus, an image with a high glossiness can be formed in the arbitrary region of the recording medium P during conveyance (step S304 in FIG. 6), and the first step ends (step S305 in FIG. 6).

After the first step ends, the second step is started in a state in which the plurality of holding claws 24 of the printing cylinder 22 holds the leading end portion of the recording medium P (step S306 in FIG. 6). In addition, the controller 74 controls the rotation motor 26 such that the recording medium P is continuously conveyed at the normal conveyance speed. Note that, although the second step is started when or after the printing cylinder 22 enters the second rotation, the second step may also be started before the printing cylinder 22 enters the second rotation.

The controller 74 controls the image former 50 such that ink is ejected from the plurality of inkjet sections 52 onto another arbitrary region of the recording medium P during conveyance (step S307 in FIG. 6). Subsequently, the controller 74 controls the emitter 54 such that ultraviolet rays in the second emission light amount equal to or smaller than the normal emission light amount are emitted to the recording medium P during conveyance (step S308 in FIG. 6). Thus, an image with a low glossiness can be formed in the other arbitrary region of the recording medium P during conveyance (step S309 in FIG. 6). Then, the second step ends when the plurality of holding claws 62 of the downstream cylinder 60 receives the leading end portion of the recording medium P, on which an image formation has been performed, from the plurality of holding claws 24 of the printing cylinder 22 and holds the leading end portion (step S310 in FIG. 6).

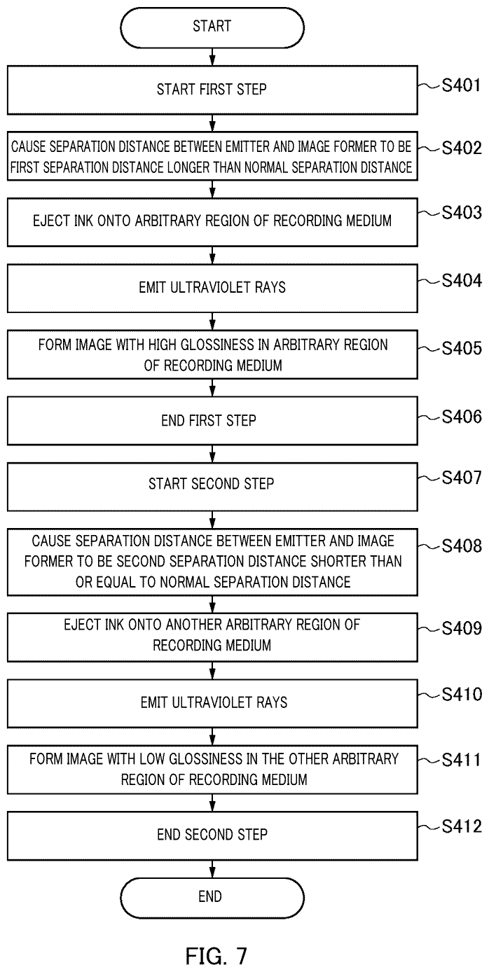

A flow of operations in the fourth control aspect of the inkjet printing apparatus 10 will be described with reference to FIGS. 1, 2, and 7. FIG. 7 is a flowchart illustrating the flow of operations in the fourth control aspect of the inkjet printing apparatus according to the present embodiment.

As illustrated in FIGS. 1, 2, and 7, the first step is started when the plurality of holding claws 24 of the printing cylinder 22 receives the leading end portion of the recording medium P from the plurality of holding claws 42 of the upstream cylinder 40 and holds the leading end portion (step S401 in FIG. 7). In addition, the controller 74 controls the position adjustment motor 58 such that the separation distance between the emitter 54 and the image former 50 becomes the first separation distance longer than the normal separation distance (step S402 in FIG. 7). Then, the controller 74 controls the rotation motor 26 such that the conveyance speed of the recording medium P becomes the normal conveyance speed, and thus, the recording medium P is conveyed at the normal conveyance speed.

The controller 74 controls the image former 50 such that ink is ejected from the plurality of inkjet sections 52 onto an arbitrary region of the recording medium P during conveyance (step S403 in FIG. 7). Subsequently, in a state in which the separation distance between the emitter 54 and the image former 50 is adjusted to the first separation distance, the controller 74 controls the emitter 54 such that ultraviolet rays are emitted to the recording medium P during conveyance (step S404 in FIG. 7). Thus, an image with a high glossiness can be formed in the arbitrary region of the recording medium P during conveyance (step S405 in FIG. 7), and the first step ends (step S406 in FIG. 7).

After the first step ends, the second step is started in a state in which the plurality of holding claws 24 of the printing cylinder 22 holds the leading end portion of the recording medium P (step S407 in FIG. 7). In addition, the controller 74 controls the rotation motor 26 such that the recording medium P is continuously conveyed at the normal conveyance speed. Then, the controller 74 controls the position adjustment motor 58 such that the separation distance between the emitter 54 and the image former 50 becomes the second separation distance shorter than or equal to the normal separation distance (step S408 in FIG. 7). Note that, although the second step is started when or after the printing cylinder 22 enters the second rotation, the second step may also be started before the printing cylinder 22 enters the second rotation.

The controller 74 controls the image former 50 such that ink is ejected from the plurality of inkjet sections 52 onto another arbitrary region of the recording medium P during conveyance (step S409 in FIG. 7). Subsequently, in a state in which the separation distance between the emitter 54 and the image former 50 is adjusted to the second separation distance, the controller 74 controls the emitter 54 such that ultraviolet rays are emitted to the recording medium P during conveyance (step S410 in FIG. 7). Thus, an image with a low glossiness can be formed in the other arbitrary region of the recording medium P during conveyance (step S411 in FIG. 7). Then, the second step ends when the plurality of holding claws 62 of the downstream cylinder 60 receives the leading end portion of the recording medium P, on which an image formation has been performed, from the plurality of holding claws 24 of the printing cylinder 22 and holds the leading end portion (step S412 in FIG. 7).

According to the configuration of the inkjet printing apparatus 10 according to the present embodiment, in a case where the step of circulating and conveying of the recording medium P is repeated a plurality of times, the controller 74 changes the printing condition for each step such that the glossiness of an image formed on the recording medium P is partially different as described above. For this reason, it is possible to form an image with a high glossiness in an arbitrary region of the recording medium P or to form an image with a low glossiness in another arbitrary region of the recording medium P only by repeating the step of circulating and conveying the recording medium P a plurality of times.

Accordingly, the inkjet printing apparatus 10 according to the present embodiment makes it possible to partially control (adjust) the glossiness of an image formed in an arbitrary region (including another arbitrary region) of the recording medium P while preventing the configuration of the inkjet printing apparatus 10 from becoming complicated.

In addition, according to the configuration of the inkjet printing apparatus 10 according to the present embodiment, in a case where an image with a high glossiness is formed in an arbitrary region of the recording medium P, the controller 74 controls the rotation motor 26 such that the conveyance speed of the recording medium P is slower. For this reason, the time until the ink ejected onto the recording medium P is cured becomes longer and, as illustrated in FIG. 3A, the ink spreads and the bulk of the ink becomes lower.

Accordingly, the inkjet printing apparatus 10 according to the present embodiment makes it possible to perform control such that the glossiness of an image formed in an arbitrary region of the recording medium P is partially increased.

In addition, according to the configuration of the inkjet printing apparatus 10 according to the present embodiment, in a case where an image with a low glossiness is formed on an arbitrary region of the recording medium P, the controller 74 controls the rotation motor 26 such that the conveyance speed of the recording medium P is faster. For this reason, the time until the ink ejected onto the recording medium P is cured becomes shorter and, as illustrated in FIG. 3B, the ink does not spread and the bulk of the ink becomes higher.

Accordingly, the inkjet printing apparatus 10 according to the present embodiment makes it possible to perform control such that the glossiness of an image formed in an arbitrary region of the recording medium P is partially decreased.

In addition, according to the configuration of the inkjet printing apparatus 10 according to the present embodiment, in a case where an image with a higher glossiness is formed in an arbitrary region of the recording medium P, the rotation motor 26, the image former 50, and the emitter 54 are controlled in two steps as described above. For this reason, the time until the ink ejected onto the recording medium P is cured becomes longer and, as illustrated in FIG. 3C, the ink spreads more and the bulk of the ink becomes extremely lower.

Accordingly, the inkjet printing apparatus 10 according to the present embodiment makes it possible to perform control such that the glossiness of an image formed in an arbitrary region of the recording medium P is partially increased.

In addition, according to the configuration of the inkjet printing apparatus 10 according to the present embodiment, in a case where an image with a high glossiness is formed in an arbitrary region of the recording medium P, the controller 74 controls the emitter 54 such that the emission light amount of ultraviolet rays is larger. For this reason, as illustrated in FIG. 3A, the ink ejected onto the recording medium P spreads and the bulk of the ink becomes lower.

Accordingly, the inkjet printing apparatus 10 according to the present embodiment makes it possible to perform control such that the glossiness of an image formed in an arbitrary region of the recording medium P is partially increased.

In addition, according to the configuration of the inkjet printing apparatus 10 according to the present embodiment, in a case where an image with a low glossiness is formed in an arbitrary region of the recording medium P, the controller 74 controls the emitter 54 such that the emission light amount of ultraviolet rays is smaller. For this reason, as illustrated in FIG. 3B, the ink ejected onto the recording medium P does not spread and the bulk of the ink becomes higher.

Accordingly, the inkjet printing apparatus 10 according to the present embodiment makes it possible to perform control such that the glossiness of an image formed in an arbitrary region of the recording medium P is partially decreased.

In addition, according to the configuration of the inkjet printing apparatus 10 according to the present embodiment, in a case where an image with a high glossiness is formed in an arbitrary region of the recording medium P, the controller 74 controls the position adjustment motor 58 such that the separation distance between the emitter 54 and the image former 50 is longer. For this reason, the time until the ink ejected onto the recording medium P is cured becomes longer and, as illustrated in FIG. 3A, the ink spreads and the bulk of the ink becomes lower.

Accordingly, the inkjet printing apparatus 10 according to the present embodiment makes it possible to perform control such that the glossiness of an image formed in an arbitrary region of the recording medium P is partially increased.

In addition, according to the configuration of the inkjet printing apparatus 10 according to the present embodiment, in a case where an image with a low glossiness is formed in another arbitrary region of the recording medium P, the position adjustment motor 58 is controlled such that the separation distance between the emitter 54 and the image former 50 is shorter. For this reason, by causing the separation distance between the emitter 54 and the image former 50 to be shorter, the time until the ink ejected onto the recording medium P is cured becomes shorter and, as illustrated in FIG. 3B, the ink does not spread and the bulk of the ink becomes higher.

Accordingly, the inkjet printing apparatus 10 according to the present embodiment makes it possible to perform control such that the glossiness of an image formed in an arbitrary region of the recording medium P is partially decreased.

Although embodiments of the present invention have been described and illustrated in detail, it is clearly understood that the same is by way of illustration and example only and not limitation, the scope of the present invention should be interpreted by terms of the appended claims.

What is claimed is:

1. A printing apparatus, comprising:
a conveyor that circulates and conveys a recording medium in a state in which the recording medium is held by a holder;
an image former that forms an image by ejecting ink onto the recording medium during conveyance;
an emitter that emits an energy ray to the recording medium on which the image has been formed; and
a hardware processor that functions as a controller that controls the conveyor, the image former, and the emitter, wherein
in a case where a step of circulating and conveying the recording medium is repeated a plurality of times in a state in which the recording medium is held by the holder, the controller changes a printing condition for each of a plurality of the steps such that a glossiness of the image formed on the recording medium is partially different.

2. The printing apparatus according to claim 1, wherein
the printing condition is a conveyance speed of the recording medium by the conveyor.

3. The printing apparatus according to claim 2, wherein
in a case where an image with a high glossiness is formed in an arbitrary region of the recording medium, the controller controls the conveyor such that the conveyance speed of the recording medium is slower than in a case where an image with a low glossiness is formed.

4. The printing apparatus according to claim 2, wherein
in a case where an image with a higher glossiness is formed in an arbitrary region of the recording medium, the controller controls the conveyor, the image former, and the emitter such that in a first step, the image is formed in the arbitrary region of the recording medium in a state in which emission of the energy ray is stopped, and in a second step after the first step ends, the energy ray is emitted to the recording medium.

5. The printing apparatus according to claim 2, wherein
in a case where an image with a low glossiness is formed in an arbitrary region of the recording medium, the controller controls the conveyor such that the conveyance speed of the recording medium is faster than in a case where an image with a high glossiness is formed.

6. The printing apparatus according to claim 1, wherein:
the ink is an ultraviolet curable gel ink and the energy ray is an ultraviolet ray, and
the printing condition is an emission light amount of an ultraviolet ray.

7. The printing apparatus according to claim 6, wherein
in a case where an image with a high glossiness is formed in an arbitrary region of the recording medium, the controller controls the emitter such that the emission light amount of the ultraviolet ray is larger than in a case where an image with a low glossiness is formed.

8. The printing apparatus according to claim 6, wherein
in a case where an image with a low glossiness is formed in an arbitrary region of the recording medium, the controller controls the emitter such that the emission light amount of the ultraviolet ray is smaller than in a case where an image with a high glossiness is formed.

9. The printing apparatus according to claim 1, further comprising a position adjuster that adjusts a position of the emitter in a direction approaching and separating from the image former in a state in which a gap between the emitter and a conveyance surface of the conveyor is maintained constant, wherein
the printing condition is a separation distance between the emitter and the image former.

10. The printing apparatus according to claim 9, wherein
in a case where an image with a high glossiness is formed in an arbitrary region of a recording medium, the controller controls the position adjuster such that the separation distance between the emitter and the image former is longer than in a case where an image with a low glossiness is formed.

11. The printing apparatus according to claim 9, wherein
in a case where an image with a low glossiness is formed in an arbitrary region of the recording medium, the controller controls the position adjuster such that the separation distance between the emitter and the image former is shorter than in a case where an image with a high glossiness is formed.

12. The printing apparatus according to claim 1, wherein
the conveyor includes:
a printing cylinder that includes, as the holder, a holding claw on an outer periphery surface side of the printing cylinder and rotates while carrying the recording medium, the holding claw holding a leading end portion of the recording medium; and
a drive source that rotates the printing cylinder.
